(19) United States
(12) Patent Application Publication
(10) Pub. No.: US 2026/0117003 A1
(43) Pub. Date: Apr. 30, 2026

(54) VANADIUM CATALYST COMPOSITION AND PREPARATION METHOD AND APPLICATION THEREOF

(71) Applicant: QINGDAO UNIVERSITY OF SCIENCE AND TECHNOLOGY, Qingdao (CN)

(72) Inventors: Lihua Na, Qingdao (CN); Xuequan Zhang, Qingdao (CN); Mingzhe Han, Qingdao (CN); Chunyu Zhang, Qingdao (CN); Heng Liu, Qingdao (CN)

(21) Appl. No.: 19/008,973

(22) Filed: Jan. 3, 2025

(30) Foreign Application Priority Data
Jul. 15, 2024 (CN) 202410941465 .0

(51) Int. Cl. C08F 4/76; C08F 10/06

(52) U.S. Cl. CPC C08F 4/76; C08F 10/06

(57) ABSTRACT

A vanadium catalyst composition and a preparation method and application thereof. The vanadium catalyst composition is composed of a vanadium complex and an electron donor, the ligand of the vanadium complex is one of fatty alcohols, amines and phosphate esters, the electron donor is a sulfoxide compound, and the structural formula is R—S(═O)—R′, R is selected from one of C₁-C₃ alkyl, aryl, C₁-C₃ alkyl substituted aryl; R′ is selected from one of C₁-C₃ alky, aromatic alkyl. An electronic donor with oxidation property is adopted, an aqueous phase extraction method is combined, and a vanadium catalyst composition with a reactivation function is synthesized by a one-step method.

### CROSS-REFERENCE TO RELATED APPLICATION

This application claims the benefit of priority under the Paris Convention to Chinese patent application No. 202410941465.0, filed on Jul. 15, 2024. The contents of the above-mentioned application are all hereby incorporated by reference.

### TECHNICAL FIELD

The invention relates to the technical field of catalysts for synthesizing ethylene propylene rubber, and in particular to a vanadium catalyst composition and preparation method and application thereof.

### BACKGROUND

At present, ethylene propylene rubber is a synthetic rubber using ethylene and propylene as main comonomers. According to the presence or absence of a third monomer, it can be divided into ethylene-propylene rubber or ethylene-propylene-diene rubber. Ethylene propylene rubber has many excellent characteristics and is widely applied to automobile parts, building materials, waterproof coiled materials, electric wires and cables, heat-resistant rubber tubes, advanced sealing materials, lubricating oil additives, polymer modified materials, plastic runways and the like, and particularly the automobile parts occupy absolute advantages in the ethylene propylene rubber consumption market at home and abroad.

Ethylene propylene rubber produced at home and abroad mostly uses vanadium compounds as main catalysts and organic aluminum compounds and activation accelerators as cocatalysts. The vanadium compounds used as the main catalyst are VX₃, VX₄, VOX₃ and VO(OR)₃₋ₙXₙ, X is halogen and mainly chlorine atoms. The VOCl₃ catalytic system (VOCl₃/Al₂Et₃Cl₃) is commonly used in industrial production in China, wherein the main catalyst VOCl₃ is prepared by high temperature chlorination of V₂O₅, and a large amount of chlorine gas is used not only to damage the health of operators, but also to cause serious environmental pollution; and the VOCl₃ is extremely sensitive to air and water, easy to decompose to generate corrosive gas, which increases storage and transportation costs, and brings many technical disadvantages such as reduction of catalytic performance and blockage of a catalyst feeding system by hydrolyzed precipitates. Therefore, a novel efficient, green and environment-friendly vanadium-based catalyst (CN200710055981.X) was developed by Zhang and the like. The synthesis of the vanadium catalyst through a safe and pollution-free aqueous phase extraction method has become a research hotspot in recent years. However, the main catalyst vanadium catalyst is gradually reduced to low-valence vanadium to be deactivated under the alkylation action of the cocatalyst, so that the vanadium catalyst is low in catalytic efficiency, fast in activity attenuation and high in catalyst dosages, and the activator ethyl trichloroacetate (ETCA) is usually used to enhance the catalytic activity of the vanadium catalyst; if the activator ethyl trichloroacetate (ETCA) is used in the industrial production process, the difficulty of the post-treatment process of ethylene propylene rubber production is increased, related problems such as separation, recovery and water pollution are brought, and the corresponding production cost is increased.

According to the invention, an electronic donor with oxidizing property is adopted, a aqueous phase extraction method is combined, and a vanadium catalyst composition with a reactivation function is synthesized by a one-step method, so that the catalytic efficiency of catalyzing ethylene/propylene or ethylene/propylene/third monomer copolymerization by a vanadium catalyst of an non-activator system is improved, the production cost is reduced, different types of ethylene propylene rubber can be developed, and the production capacity and market competitiveness of the ethylene propylene rubber in China are improved.

### SUMMARY

The invention aims to overcome the defects of the prior art and provides a vanadium catalyst composition and a preparation method and application thereof.

In order to achieve the above object, the technical solution of the present invention is: a vanadium catalyst composition, wherein the vanadium catalyst composition is composed of a vanadium complex and an electron donor, the ligand of the vanadium complex is one of fatty alcohol, amine and phosphate esters, and the structural formula of the electron donor is as shown in formula (I):

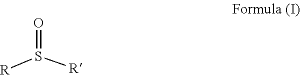

R in the electron donor is selected from one of C₁-C₃ alkyl, aryl, C₁-C₃ alkyl substituted aryl; R′ is selected from one of C₁-C₃ alky, aromatic alkyl.

Further, the fatty alcohol is C₅-C₁₈ fatty alcohol; the phosphate ester is selected from one of di(2-ethylhexyl)phosphate, 2-ethylhexyl phosphate 2-ethylhexyl ester, di(2-ethylhexyl)phosphonic acid; and the amine is selected from one of N₂₃₅, N₁₉₂₃, tri-n-octylamine.

Another technical solution of the present invention is: a method for preparing the vanadium catalyst composition, which is prepared by an aqueous one-step method, comprising the following steps:
(1) mixing an extractant, an electron donor and a diluent to obtain an extractant diluent, wherein the diluent is saturated alkane of C₆-C₈ or toluene, and the extractant is a ligand of a vanadium complex;
(2) mixing the extractant diluent prepared in step (1) with an aqueous solution of an inorganic vanadium compound, and performing extraction and phase separation to obtain a dilute solution of a vanadium catalyst composition; the inorganic vanadium compound is selected from one or two of vanadium pentoxide (V₂O₅), sodium metavanadate (NaVO₃), ammonium metavanadate (NH₄VO₃), calcium pyrovanadate (Ca₂ V₂O₇), calcium orthovanadate (Ca₃ (VO₄)₂), and sodium hexavanadate Na₂H₂V₆O₁₇).

Further, in step (2), an inorganic vanadium compound is used instead of an aqueous solution of the inorganic vanadium compound, and concentrated hydrochloric acid is added for extraction and phase separation.

Further, the method further comprises a step (3) of performing reduced pressure distillation on the dilute solution of the vanadium catalyst composition prepared in the step (2) under the protection of a stabilizer to remove a diluent to obtain the vanadium catalyst composition.

Further, the molar ratio of the extractant to the electron donor in step (1) is 1:(0.2-2.0).

Further, in step (1), the volume content of the extractant in the extractant diluent is 20-45%.

Further, in step (2), the pH value of the aqueous solution of the inorganic vanadium compound is adjusted to 1-10 with an acid-base solution, and the concentration of the vanadium element in the aqueous solution of the inorganic vanadium compound is 0.4-1.5 mol/L, and the molar ratio of the extractant to the vanadium element in the inorganic vanadium compound or the aqueous solution of the inorganic vanadium compound is (1-3.0): 1.

Further, in step (2), the volume ratio of the total aqueous phase to the total organic phase is 1:(1-3) before extracting and separating the phases.

Further, in step (3), the stabilizer is a C₂-C₄ fatty acid with a mass concentration less than 1%; the temperature of the reduced pressure distillation is 20-70° C., and the time of the reduced pressure distillation is 0.5 to 4 hours.

Still another technical solution of the present invention is: an application of the vanadium catalyst composition, wherein the application comprises synthesis of ethylene propylene rubber.

Further, in an organic solvent, ethylene and propylene are subjected to a copolymerization reaction by using the vanadium catalyst composition and the co-catalyst organoaluminum compound to obtain the ethylene-propylene rubber.

Further, the concentration of the vanadium catalyst composition in the organic solvent is 1×10⁻⁴ mol/L-2×10⁻³ mol/L; preferably3×10⁻⁴ mol/L-1.5×10⁻³ mol/L; the molar ratio of ethylene to propylene is 1:(1-5); the organic solvent is selected from one or more of n-hexane, cyclohexane, heptane and toluene; the temperature of the polymerization reaction is 0-70° C., preferably 20-50° C.; the pressure of the polymerization reaction is 0.1-0.6 MPa, preferably 0.3-0.5 MPa; the time of the polymerization reaction is 10-90 min, preferably 15-60 min.

Further, after the polymerization reaction is completed, the ethylene-propylene rubber is obtained through post-treatment. The post-treatment process comprises the following steps: adding a polymerization reaction product into a hydrochloric acid-ethanol solution to terminate polymerization, wherein the mass percentage of hydrochloric acid in the hydrochloric acid-ethanol solution is 5%, washing and settling with ethanol, and then drying in vacuum to obtain the final ethylene-propylene rubber.

Further, ethylene, propylene and non-conjugated diene are subjected to copolymerization reaction in the organic solvent by using the vanadium catalyst composition and the co-catalyst organoaluminum compound to prepare the ethylene-propylene-diene rubber.

Further, the concentration of the vanadium catalyst composition in the organic solvent is 1×10⁻⁴ mol/L-2×10⁻³ mol/L; preferably 3×10⁻⁴ mol/L-1.5×10⁻³ mol/L; the molar ratio of ethylene to propylene is 1:(1-4); the non-conjugated diene is selected from dicyclopentadiene (DCPD), 5-ethylidene-2-norbornene (ENB), 5-vinyl-2-norbornene (VNB), 4-ethylene-1-cyclohexene (VCH) or 1,4-hexadiene (HD); the addition amount of the non-conjugated diene is 1-10% of the mass fraction of the final ethylene-propylene-diene rubber; the organic solvent is selected from one or more of n-hexane, cyclohexane, heptane and toluene; the temperature of the polymerization reaction is 0-70° C., preferably 20-50° C.; the pressure of the polymerization reaction is 0.1-0.6 MPa, preferably 0.3-0.5 MPa; the time of the polymerization reaction is 10-90 min, preferably 15-60 min.

Further, after the polymerization reaction is completed, the ethylene-propylene-diene rubber is obtained through post-treatment; and the post-treatment process comprises the following steps: adding a product of the polymerization reaction into a hydrochloric acid-ethanol solution to stop polymerization, wherein the mass percentage of hydrochloric acid in the hydrochloric acid-ethanol solution is 5%, washing and settling with ethanol, and then drying in vacuum to obtain the final ethylene-propylene-diene rubber.

Further, the organic aluminum compound is selected from at least one of ethylaluminum sesquichloride (Al₂ (C₂H₅)₃Cl₃), ethylaluminum dichloride (AlC₂H₅Cl₂), diethylaluminum chloride (Al(C₂H₅)₂Cl) and isobutylaluminum dichloride (AlC₄H₉C₁).

The ratio of the amount of the main catalyst vanadium catalyst composition to the amount of the cocatalyst is not particularly limited in the present invention, and can be selected according to the routine of those skilled in the art.

Benefits of the invention: The vanadium catalyst composition comprises a vanadium complex and a sulfoxide compound electron donor. The vanadium catalyst composition has good stability in water and air, long storage time and high catalytic activity. By introducing the electron donor into the vanadium complex, the vanadium metal active center can be stabilized, the service life of a vanadium catalyst is prolonged, the catalytic activity and the third monomer insertion rate are improved, and the vanadium catalyst is beneficial for replacing industrial catalyst VOCl₃ to implement on industrial devices and is used for ethylene propylene rubber production; the preparation method of the vanadium catalyst composition is simple, safe to use and mild in reaction conditions, and the defects of the existing industrial catalyst VOCl₃ in the preparation and use processes are overcome, the third monomer insertion rate is high, and the production cost of ethylene propylene rubber is reduced; the experimental results show that the conversion rate of the third monomer in the ethylene, propylene, and third monomer copolymers obtained by its catalysis can reach up to 90%. In addition, the vanadium catalyst composition can develop different types of ethylene propylene rubber, and the production capacity and market competitiveness of the ethylene propylene rubber in China are improved.

### BRIEF DESCRIPTION OF DRAWINGS

FIG. 1 shows the ¹HNMR spectrum of the vanadium catalyst composition prepared in Embodiment 1.

FIG. 2 shows the DSC spectrum of the ethylene-propylene-diene rubber prepared in Embodiments 8-11.

FIG. 3 is GPC spectra of ethylene-propylene-diene rubber prepared in Embodiment 12 and Comparative Embodiment 1.

FIG. 4 shows polymerization temperature curves of ethylene-propylene rubber prepared in Embodiment 20 and Comparative Embodiment 2.

### DETAILED DESCRIPTION

For a further understanding of the present invention, the preferred embodiments of the present invention are described below in conjunction with embodiments, but it should be understood that these descriptions are merely intended to further illustrate the features and advantages of the present invention and are not intended to limit the claims of the present invention.

### Embodiment 1

A preparation method of a vanadium catalyst composition comprises the following steps: adding 100 ml of pure water and 37 g of NaVO₃ into a 1000 ml beaker to prepare a slurry solution, diluting the slurry solution to 400 ml with pure water, and heating to fully dissolve the NaVO₃; adding 48.2 g of Na₂SO₃ in batches into the solution, uniformly stirring, dropwise adding 90 ml of a sulfuric acid aqueous solution with sulfuric acid to water volume ratio V:V of 1:1, stirring the solution for 60 minutes at 95° C., and changing the solution into dark blue; and cooling the solution to room temperature, filtering the solution with a funnel to filter out insoluble substances, and adding deionized water to set the volume of the solution to 500 ml to obtain an inorganic vanadium compound solution.

16 ml P204 extractant was added to 6.2 g of electron donor dimethyl sulfoxide and diluted to 60 ml with hexane to obtain an extractant diluent.

60 ml of the above extractant diluent and 10 ml of 6 mol/L NaOH solution were added to a separatory funnel, and the separatory funnel was placed on a Kang's oscillator and shaken for 5 min, then 50 ml of the above inorganic vanadium compound solution was added, and the two phases were fully mixed under the vibration of the Kang's oscillator for 20 min. Then standing for about 1 h to separate phases, discharging the raffinate aqueous phase at the lower layer from the lower opening, and taking the upper organic phase to obtain a vanadium compound saturated alkane solution. Sampling analysis showed that the total vanadium concentration Σ[V]=0.53 mol/L, and the extraction rate was 78% by redox titration.

The above vanadium compound saturated alkane solution was placed in a flask, 0.20 ml of propionic acid was added, under the protection of nitrogen, the mixture was heated at 40° C. Under reduced pressure for 3 h, and hexane was removed to obtain a blue liquid, i.e., the vanadium catalyst composition V1. The vanadium catalyst composition V1 ¹H NMR spectrum is shown in FIG. 1.

### Embodiment 2

A preparation method of a vanadium catalyst composition comprises the following steps: adding 100 ml of pure water and 26.4 g of V₂O₅ into a 1000 ml beaker to prepare a slurry solution, then diluting the slurry solution with pure water to 400 ml, adding 12.0 g of NaOH into the slurry solution, dissolving V₂O₅ to generate a NaVO₃ solution; adding 25 g of oxalic acid (H₂C₂O₄·2H₂O) into the solution in batches, stirring at 95° C. until the solid is dissolved, and dropwise adding 90 ml of a hydrochloric acid aqueous with hydrochloric acid to water volume ratio V:V of 1:1; taking and cooling the solution to room temperature, filtering with a funnel to filter out insoluble substances, and adding deionized water to set the volume of the solution to 500 ml to obtain an inorganic vanadium compound solution.

26.2 ml P507 extractant was added to 0.45 g of electron donor dimethyl sulfoxide and diluted to 60 ml with hexane to obtain an extractant diluent.

60 ml of the above extractant diluent and 10 ml of 6 mol/L NaOH solution were added to a separatory funnel, and the separatory funnel was placed on a Kang's oscillator and shaken for 5 min, then 50 ml of the above inorganic vanadium compound solution was added, and the two phases were fully mixed under the vibration of the Kang's oscillator for 20 min. Then, a time standing for 15 min, the aqueous phase was released, then 20 ml of the inorganic vanadium compound solution was added, and the solution was vibrated for 20 min by a Kang's oscillator, then standing for about 1 h to separate phases, discharging the raffinate aqueous phase at the lower layer from the lower opening, and taking the upper organic phase to obtain a vanadium compound saturated alkane solution. Sampling analysis showed that the total vanadium concentration Σ[V]-0.57 mol/L, and the extraction rate was 98% by redox titration.

The above vanadium compound saturated alkane solution was placed in a flask, 2.0 ml of propionic acid was added, under the protection of nitrogen, the mixture was heated at 40° C., under reduced pressure for 3 h, and hexane was removed to obtain a blue liquid, i.e., the vanadium catalyst composition V2.

### Embodiment 3

A preparation method of a vanadium catalyst composition comprises the following steps: adding 14 ml of an isooctanol extractant and 1.4 g of electron donor dimethyl sulfoxide into a separating funnel, and diluting to 60 ml with hexane to obtain an extractant diluent. 5 g NaVO₃ is used as an inorganic vanadium compound, and the inorganic vanadium compound is added into the above extractant diluent, then 25 ml of 37 wt % concentrated hydrochloric acid is added, and the separatory funnel is placed on a Kang's oscillator to be shaken for 15 min, so that the two phases are fully mixed. Then standing for about 1 h to separate phases, discharging the raffinate aqueous phase at the lower layer from the lower opening, and taking the upper organic phase to obtain a vanadium compound saturated alkane solution. Sampling analysis showed that the total vanadium concentration Σ[V]=0.50 mol/L, and the extraction rate was 72% by redox titration.

The above vanadium compound saturated alkane solution was placed in a flask, 1.0 ml of propionic acid was added, and under nitrogen protection, reduced pressure was performed at 20° C. for 4 h, and hexane was removed to obtain an organic solution, i.e., the vanadium catalyst composition V3.

### Embodiment 4

A preparation method of a vanadium catalyst composition comprises the following steps: adding 14 ml of an isooctanol extractant and 1.4 g of electron donor dimethyl sulfoxide into a separating funnel, and diluting to 60 ml with hexane to obtain an extractant diluent. 6 g of Ca₂ V₂O₇ is used as an inorganic vanadium compound, and the inorganic vanadium compound is added into the above extractant diluent, then 21 ml of 37 wt % concentrated hydrochloric acid is added, and the separating funnel is placed on a Kang's oscillator to be shaken for 15 min, so that two phases are fully mixed. Then standing for about 1 h to separate phases, discharging the raffinate aqueous phase at the lower layer from the lower opening, and taking the upper organic phase to obtain a vanadium compound saturated alkane solution. Sampling analysis showed that the total vanadium concentration Σ[V]=0.50 mol/L, and the extraction rate was 92% by redox titration.

The above vanadium compound saturated alkane solution was placed in a flask, 1.0 ml of propionic acid was added, and under nitrogen protection, reduced pressure was performed at 40° C. for 4 h, and hexane was removed to obtain an organic solution, i.e., the vanadium catalyst composition V4.

### Embodiments 5-7

Isoamyl alcohol, octadecanol and N₂₃₅ were used respectively to replace isooctanol in Embodiment 4 as an extractant, ethyl methyl sulfoxide, methyl phenyl sulfoxide and n-propyl sulfoxide were used respectively to replace dimethyl sulfoxide in Embodiment 4 as an electron donor, n-hexane, toluene and heptane were used respectively to replace hexane in Embodiment 4 as a diluent, and the extractant and the electron donor were prepared into 60 ml of extractant diluent. The vanadium catalyst composition was prepared by the same method as in Embodiment 4 to obtain vanadium catalyst compositions V5-V7, respectively, and detailed process conditions and preparation results are listed in Table 1.

TABLE 1
Embodiments 3-7 Raw Material Ratio and Extraction Rate

| | | | | | | Temperature | |
|---|---|---|---|---|---|---|---|
| | | | | | | Of the | Time of the |
| | | | | | | reduced | reduced |
| | | | Inorganic | Concentrated | | pressure | pressure |
| | | | vanadium | hydrochloric | Extraction | distillation | distillation |
| Embodiment | Extractant | electron donor | compound (g) | acid (ml) | Rate (%) | (° C.) | (h) |
| Embodiment 3 | Isooctanol | dimethyl sulfoxide | NaVO₃(5 g) | 25 | 72.0 | 20 | 4 |
| Embodiment 4 | Isooctanol | dimethyl sulfoxide | Ca₂V₂O₇(6 g) | 21 | 92.0 | 40 | 4 |
| Embodiment 5 | Isoamyl alcohol | ethyl methyl sulfoxide | Ca₂V₂O₇(6 g) | 21 | 77.7 | 30 | 4 |
| Embodiment 6 | Octadecanol | methyl phenyl sulfoxide | Ca₂V₂O₇(6 g) | 21 | 69.7 | 70 | 4 |
| Embodiment 7 | N₂₃₅ | n-propyl sulfoxide | Ca₂V₂O₇(6 g) | 21 | 88.9 | 50 | 4 |

### Embodiments 8-11

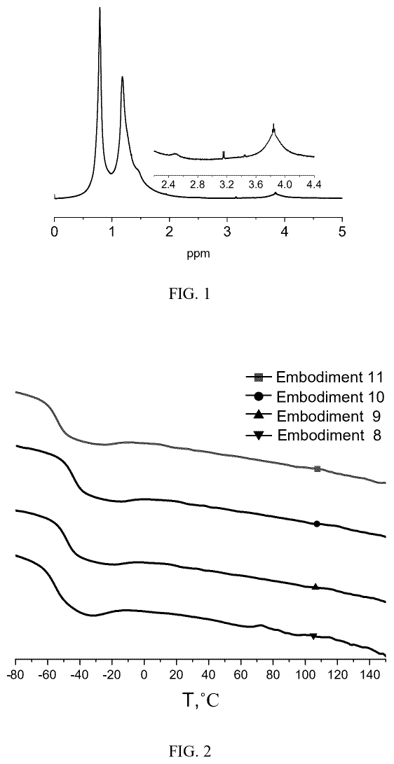

The reaction kettle used for polymerization was installed and kept closed and replaced with nitrogen for 3 times; respectively adding 0.025 mmol of a vanadium catalyst composition (V1-V4) prepared in Embodiment 1 to Embodiment 4, 0.4 mmol of an organoaluminum compound, 0.25 g of ENB and 50 ml of hexane into the reaction kettle; introducing mixed gas of ethylene and propylene with the molar ratio of ethylene to propylene of 1:2, controlling the polymerization pressure at 0.4 MPa, 200 r/min stirring, reacting at 20° C. for 30 min, after polymerization is finished, adding 5% by mass of a hydrochloric acid-ethanol solution into the polymerization product to stop polymerization, washing and settling with ethanol, and then drying under vacuum at the temperature of 40° C. to constant weight to obtain the ethylene-propylene-diene rubber polymer. The specific experimental results and characterization data are shown in Table 2, and the DSC spectra of the prepared ethylene-propylene-diene rubber polymer are shown in FIG. 2.

TABLE 2
The raw material ratio and the structural parameters of prepared
ethylene-propylene-diene rubber in Embodiments 8-11

| | | | | Glass | | | Polymer | Double |
|---|---|---|---|---|---|---|---|---|
| | vanadium | | Polymer | Transition | | | C₃ | bond |
| | catalyst | Organoaluminum | Yield | Temperature | Mn, | Mw/ | content | content |
| Embodiment | composition | compound | (g) | Tg(° C.) | (×10⁴) | Mn | (wt %) | (wt %) |
| Embodiment 8 | V1 | Al(C₂H₅)₂Cl | 2.8 | −54.2 | 13.5 | 3.6 | 26.5 | 6.6 |
| Embodiment 9 | V2 | AlC₄H₉Cl₂ | 2.5 | −52.4 | 15.7 | 2.9 | 25.8 | 4.9 |
| Embodiment 10 | V3 | AlC₂H₅Cl₂ | 6 | −54.9 | 19.0 | 3.4 | 29.0 | 7.2 |
| Embodiment 11 | V4 | Al₂(C₂H₃)₃Cl₃ | 3.1 | −55.6 | 19.3 | 3.4 | 32.2 | 7.6 |

### Embodiments 12-15

The reaction kettle used for polymerization was installed and kept closed and replaced with nitrogen for 3 times; respectively adding 0.025 mmol of the vanadium catalyst composition V4 prepared in Embodiment 4, 0.5 mmol of Al₂ (C₂H₅)₃Cl₃, 0.3 g of third monomer non-conjugated diene and 50 ml of hexane into the reaction kettle; introducing mixed gas of ethylene and propylene with the molar ratio of ethylene to propylene of 1:2, controlling the polymerization pressure at 0.4 MPa, 200 r/min stirring, reacting at 20° C. for 30 min, after polymerization is finished, adding 5% by mass of a hydrochloric acid-ethanol solution into the polymerization product to stop polymerization, washing and settling with ethanol, and then drying under vacuum at the temperature of 40° C. to constant weight to obtain the ethylene-propylene-diene rubber polymer. The specific experimental results and characterization data are shown in Table 3.

The non-conjugated dienes used in Embodiments 12-15 were 5-vinyl-2-norbornene (VNB), dicyclopentadiene (DCPD), 4-ethylene-1-cyclohexene (VCH), and 1,4-hexadiene (HD), respectively.

TABLE 3
Structural parameters of the ethylene-propylene-diene rubber prepared in Embodiments 12-15

| | | third | | | | | | |
|---|---|---|---|---|---|---|---|---|
| | | monomer | | Glass | | | Polymer | Double |
| | vanadium | non- | Polymer | Transition | | | C₃ | bond |
| | catalyst | conjugated | Yield | Temperature | Mn, | Mw/ | content | content |
| Embodiment | composition | diene | (g) | Tg(° C.) | (×10⁴) | Mn | (wt %) | (wt %) |
| Embodiment 12 | V4 | VNB | 2.9 | −50.2 | 18.0 | 2.9 | 30.3 | 8.2 |
| Embodiment 13 | V4 | DCPD | 3.0 | −51.1 | 18.3 | 2.8 | 26.2 | 5.2 |
| Embodiment 14 | V4 | VCH | 2.6 | −49.1 | 15.5 | 4.1 | 27.0 | 6.4 |
| Embodiment 15 | V4 | HD | 2.5 | −52.3 | 17.3 | 2.7 | 28.3 | 6.7 |

### Embodiments 16-19

The reaction kettle used for polymerization was installed and kept closed and replaced with nitrogen for 3 times; 0.075 mmol of the vanadium catalyst composition (V4-V7) prepared in Embodiment 4 to Embodiment 7, 1.5 mmol of ethylaluminum dichloride (AlC₂H₅Cl₂) and 50 ml of hexane were respectively added into the reaction kettle; mixed gas of ethylene and propylene with a molar ratio of ethylene to propylene of 4:5 was introduced, the polymerization pressure was controlled to be 0.5 MPa and stirred at 200 r/min, the reaction was performed at different polymerization temperatures for 60 min, after the polymerization was completed, a hydrochloric acid-ethanol solution with a mass percentage of 5% was added into the polymerization product to terminate the polymerization, and the mixture was washed and settled with ethanol, and then dried under vacuum at the temperature of 40° C. to constant weight to obtain the ethylene-propylene rubber polymer. The ethylene-propylene rubber polymer was characterized, and the results are shown in Table 4.

The polymerization temperatures of Embodiments 16-19 were 70° C., 0° C., 30° C., and 50° C., respectively.

TABLE 4
Structural parameters of the ethylene-propylene rubber prepared in Embodiments 16-19

| | | | | Glass | | | Polymer |
|---|---|---|---|---|---|---|---|
| | vanadium | | Polymer | Transition | | | C₃ |
| | catalyst | Polymerization | Yield | Temperature | Mn, | Mw/ | content |
| Embodiment | composition | temperature | (g) | Tg(° C.) | (×10⁴) | Mn | (wt %) |
| Embodiment 16 | V4 | 70 | 1.5 | −48.5 | 20.4 | 3.7 | 23.1 |
| Embodiment 17 | V5 | 0 | 3.3 | −58.3 | 20.3 | 2.7 | 30.1 |
| Embodiment 18 | V6 | 30 | 3.6 | −52.1 | 17.3 | 3.4 | 21.2 |
| Embodiment 19 | V7 | 50 | 3.5 | −50.5 | 20.6 | 4.1 | 28.3 |

### Embodiment 20

The reaction kettle used for polymerization was installed and kept closed and replaced with nitrogen for 3 times; 0.025 mmol of the vanadium catalyst composition (V4) prepared in Embodiment 4, 0.5 mmol of ethylaluminum sesquichloride (Al₂ (C₂H₅)₃Cl₃), and 50 ml of hexane were added into the reaction kettle respectively; a mixed gas of ethylene and propylene with the molar ratio of ethylene to propylene of 1:2 was introduced, the polymerization pressure was controlled to be 0.4 MPa and stirred at 200 r/min, the reaction was performed at 20° C. for 30 min, after the polymerization was completed, 5% by mass of a hydrochloric acid-ethanol solution was added into the polymerization product to terminate the polymerization, the polymerization was washed and settled with ethanol, and then the mixture was dried to constant weight under vacuum at the temperature of 40° C. to obtain an ethylene-propylene rubber polymer. The ethylene-propylene rubber polymer was characterized, and the results are shown in Table 5.

### Comparative Embodiment 1

(1) Replace the closed 0.1 L reactor with nitrogen, and replace it with nitrogen for 3 times;
(2) 0.025 mmol vanadium catalyst (VOCl₃), 0.5 mmol ethylaluminum sesquichloride (Al₂(C₂H₅)₃Cl₃) and 0.3 g VNB were added in sequence;
(3) adding 50 ml of solvent hexane, then introducing a mixed gas of ethylene and propylene having a molar ratio of ethylene to propylene of 1:2, stirring at 200 r/min under the pressure of 0.4 MPa, and reacting at a temperature of 20° C. for 30 min;
(4) The polymerization product was terminated with 5% mass percent hydrochloric acid-ethanol solution, washed and settled with ethanol, and dried under vacuum at 40° C. to constant weight to obtain 1.5 g ethylene-propylene-diene rubber.

### Comparative Embodiment 2

(1) Replace the closed 0.1 L reactor with nitrogen, and replace it with nitrogen for 3 times;
(2) 0.025 mmol vanadium catalyst (VOCl₃) and 0.5 mmol ethylaluminum sesquichloride (Al₂(C₂H₅)₃Cl₃) were sequentially added;
(3) adding 50 ml of solvent hexane, then introducing a mixed gas of ethylene and propylene having a molar ratio of ethylene to propylene of 1:2, stirring at 200 r/min under the pressure of 0.4 MPa, and reacting at a temperature of 20° C. for 30 min;
(4) The polymerization product was terminated with 5% mass percent hydrochloric acid-ethanol solution, washed with ethanol for sedimentation, and dried under vacuum at 40° C. to constant weight to obtain 1.7 g of ethylene-propylene rubber.

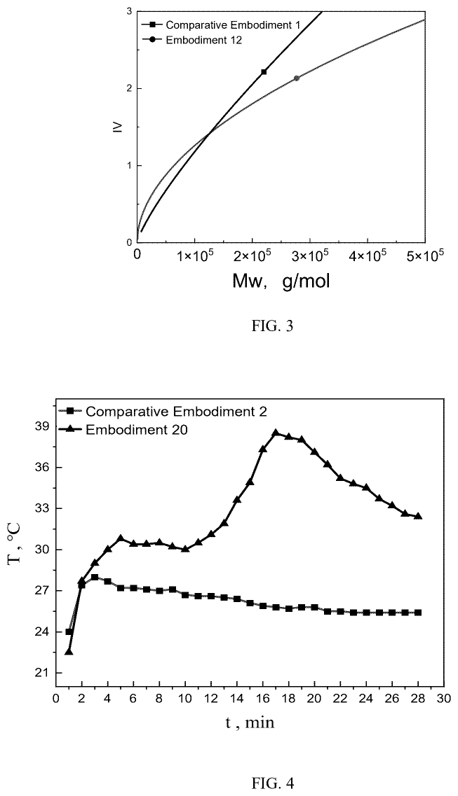

The vanadium catalyst composition containing the extractant and the electron donor prepared in Embodiment 4 of the present invention and the VOCl₃ catalyst used in industrial production of ethylene propylene rubber were used to prepare ethylene propylene rubber polymerization experiments with VNB as the third monomer or without adding the third monomer for comparison, and the results are shown in Table 5, and FIG. 3 and FIG. 4.

TABLE 5
Comparison of Structure parameters of ethylene propylene
rubber prepared by using different catalysts

| | vanadium | | | | Polymer C3 | |
|---|---|---|---|---|---|---|
| Embodiment | catalyst | Extractant | electron donor | Yield(g) | content(wt %) | Tg(° C.) |
| Embodiment 12 | V4 | Isooctanol | Dimethyl sulfoxide | 2.9 | 30.7 | −50.2 |
| Embodiment 20 | V4 | Isooctanol | Dimethyl sulfoxide | 3.5 | 33.9 | −55.2 |
| Comparative | VOCl3 | / | / | 1.5 | 31.8 | −52.0 |
| Embodiment 1 | | | | | | |
| Comparative | VOCl3 | / | / | 1.7 | 33.5 | −54.5 |
| Embodiment 2 | | | | | | |

Remark: “/” represents no addition of this substance.

The results of the polymerization in Table 5 show that: (1) the catalytic efficiency of the ethylene-propylene-diene rubber prepared by using the vanadium catalyst composition V4 prepared in Embodiment 4 of the present invention is 1.9 times that of the industrial catalyst VOCl₃ (specific experimental conditions are shown in Embodiment 12 and Comparative Embodiment 1), and the ethylene-propylene-diene rubber with a branched structure with a high added value can be prepared, as shown in FIG. 3; (2) the catalytic efficiency of the ethylene-propylene-diene rubber prepared by using the vanadium catalyst composition V4 prepared in Embodiment 4 of the present invention is 2.05 times that of the industrial catalyst VOCl₃ (specific experimental conditions are shown in Embodiment 20 and Comparative Embodiment 2), and FIG. 4 is a curve graph of the temperature change of the polymerization reaction.

The ethylene propylene rubber prepared by using the vanadium catalyst composition of the present invention is analyzed by DSC, NMR and high-temperature GPC, and results show that the vanadium catalyst composition of the present invention can be used for developing different types of ethylene propylene rubber, and the ethylene-propylene-diene rubber with a branched structure can be prepared, so that postprocessing is facilitated.

Under the condition of ensuring the polymerization activity, the consumption of organoaluminum compounds is reduced, a vanadium catalyst composition containing oxidizing electron donors is selected, ethylene, propylene or ethylene, propylene and non-conjugated diene copolymerization is carried out, the stable vanadium metal active center can be improved, and the catalytic activity of a vanadium catalyst and the third monomer insertion rate are improved; meanwhile, the use amount of a cocatalyst organic aluminum compound is reduced, an industrial catalyst VOCl₃ is favorably replaced to be implemented on an industrial device, and the catalyst is used as a vanadium-based catalyst for ethylene propylene rubber production; the vanadium catalyst composition of the present invention is stable, the preparation method is simple, the use is safe, the reaction conditions are mild, and many defects of the existing industrial catalyst VOCl₃ in the preparation and use processes are overcome.

The above embodiments are only preferred solutions of the present invention, and are not intended to limit the present invention in any form, and there are other variations and modifications without exceeding the technical solutions described in the claims.

What is claimed is:

1. A vanadium catalyst composition, comprising a vanadium complex and an electron donor, wherein the ligand of the vanadium complex is one of fatty alcohols, amines, and phosphate esters, and the structural formula of the electron donor is as shown in Formula (I): 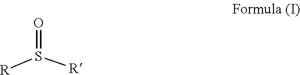
R in the electron donor is selected from one of C₁-C₃ alkyl, aryl, C₁-C₃ alkyl substituted aryl; R′ is selected from one of C₁-C₃ alky, aromatic alkyl.

2. The vanadium catalyst composition according to claim 1, wherein the fatty alcohol is C₅-C₁₈ fatty alcohol; the phosphate ester is selected from one of di(2-ethylhexyl)phosphate, 2-ethylhexyl 2-ethylhexyl phosphate ester, and di(2-ethylhexyl)phosphonic acid; the amine is selected from one of N₂₃₅, N₁₉₂₃, and tri-n-octylamine.

3. A method for preparing the vanadium catalyst composition according to claim 1, wherein is prepared by an aqueous one-step method, comprising the following steps:
(1) mixing an extractant, an electron donor and a diluent to obtain an extractant diluent, wherein the diluent is saturated alkane of C₆-C₈ or toluene, and the extractant is a ligand of a vanadium complex;
(2) mixing the extractant diluent prepared in step (1) with an inorganic vanadium compound or an aqueous solution of the inorganic vanadium compound, and performing extraction and phase separation to obtain a dilute solution of the vanadium catalyst composition, wherein the inorganic vanadium compound is selected from one or two of vanadium pentoxide, sodium metavanadate, ammonium metavanadate, calcium pyrovanadate, calcium orthovanadate, and sodium hexavanadate.

4. The method for preparing a vanadium catalyst composition according to claim 3, further comprising a step (3) of performing reduced pressure distillation on the dilute solution of the vanadium catalyst composition prepared in step (2) under the protection of a stabilizer to remove a diluent to obtain the vanadium catalyst composition.

5. The method for preparing the vanadium catalyst composition according to claim 3, wherein the molar ratio of the extractant to the electron donor in step (1) is 1:(0.2-2.0).

6. The method for preparing the vanadium catalyst composition according to claim 3, wherein in step (2), the pH value of the aqueous solution of the inorganic vanadium compound is adjusted to 1-10 with an acid-base solution, the concentration of the vanadium element in the aqueous solution of the inorganic vanadium compound is 0.4-1.5 mol/L, and the molar ratio of the extractant to the vanadium element in the inorganic vanadium compound or the aqueous solution of the inorganic vanadium compound is (1-3.0): 1.

7. The method for preparing the vanadium catalyst composition according to claim 3, wherein in step (2), the volume ratio of the total aqueous phase to the total organic phase is 1:(1-3) before extracting and separating the phases.

8. The method for preparing the vanadium catalyst composition according to claim 4, wherein in step (3), the stabilizer is a C₂-C₄ fatty acid with a mass concentration less than 1%; the temperature of the reduced pressure distillation is 20-70° C., and the time of the reduced pressure distillation is 0.5-4 hours.

9. A method for preparing the vanadium catalyst composition according to claim 2, wherein is prepared by an aqueous one-step method, comprising the following steps:
(1) mixing an extractant, an electron donor and a diluent to obtain an extractant diluent, wherein the diluent is saturated alkane of C₆-C₈ or toluene, and the extractant is a ligand of a vanadium complex;
(2) mixing the extractant diluent prepared in step (1) with an inorganic vanadium compound or an aqueous solution of the inorganic vanadium compound, and performing extraction and phase separation to obtain a dilute solution of the vanadium catalyst composition, wherein the inorganic vanadium compound is selected from one or two of vanadium pentoxide, sodium metavanadate, ammonium metavanadate, calcium pyrovanadate, calcium orthovanadate, and sodium hexavanadate.

10. The method for preparing a vanadium catalyst composition according to claim 9, further comprising a step (3) of performing reduced pressure distillation on the dilute solution of the vanadium catalyst composition prepared in step (2) under the protection of a stabilizer to remove a diluent to obtain the vanadium catalyst composition.

11. The method for preparing the vanadium catalyst composition according to claim 9, wherein the molar ratio of the extractant to the electron donor in step (1) is 1:(0.2-2.0).

12. The method for preparing the vanadium catalyst composition according to claim 9, wherein in step (2), the pH value of the aqueous solution of the inorganic vanadium compound is adjusted to 1-10 with an acid-base solution, the concentration of the vanadium element in the aqueous solution of the inorganic vanadium compound is 0.4-1.5 mol/L, and the molar ratio of the extractant to the vanadium element in the inorganic vanadium compound or the aqueous solution of the inorganic vanadium compound is (1-3.0): 1.

13. The method for preparing the vanadium catalyst composition according to claim 9, wherein in step (2), the volume ratio of the total aqueous phase to the total organic phase is 1:(1-3) before extracting and separating the phases.

14. The method for preparing the vanadium catalyst composition according to claim 10, wherein in step (3), the stabilizer is a C₂-C₄ fatty acid with a mass concentration less than 1%; the temperature of the reduced pressure distillation is 20-70° C., and the time of the reduced pressure distillation is 0.5-4 hours.

15. An application of the vanadium catalyst composition of claim 1, wherein the application comprises synthesis of ethylene propylene rubber.

16. The application according to claim 15, wherein ethylene-propylene rubber is prepared by performing ethylene and propylene copolymerization reaction using the vanadium catalyst composition and the co-catalyst organoaluminum compound in an organic solvent; and ethylene-propylene-diene rubber is prepared by performing ethylene, propylene and non-conjugated diene copolymerization reaction using the vanadium catalyst composition and the co-catalyst organoaluminum compound in an organic solvent.

17. An application of the vanadium catalyst composition of claim 2, wherein the application comprises synthesis of ethylene propylene rubber.

18. The application according to claim 17, wherein ethylene-propylene rubber is prepared by performing ethylene and propylene copolymerization reaction using the vanadium catalyst composition and the co-catalyst organoaluminum compound in an organic solvent; and ethylene-propylene-diene rubber is prepared by performing ethylene, propylene and non-conjugated diene copolymerization reaction using the vanadium catalyst composition and the co-catalyst organoaluminum compound in an organic solvent.
